(19) United States
(12) Patent Application Publication
(10) Pub. No.: US 2013/0235364 A1
(43) Pub. Date: Sep. 12, 2013

(54) TIME OF FLIGHT SENSOR, CAMERA USING TIME OF FLIGHT SENSOR, AND RELATED METHOD OF OPERATION

(71) Applicant: SAMSUNG ELECTRONICS CO., LTD., Suwon-si (KR)

(72) Inventors: KYU-MIN KYUNG, SEOUL (KR); TAE-CHAN KIM, YONGIN-SI (KR); KWANG-HYUK BAE, SEOUL (KR); SEUNG-HEE LEE, HWASEONG-SI (KR)

(73) Assignee: SAMSUNG ELECTRONICS CO., LTD., SUWON-SI (KR)

(21) Appl. No.: 13/761,199

(22) Filed: Feb. 7, 2013

(30) Foreign Application Priority Data
Mar. 7, 2012 (KR) 10-2012-0023600

(51) Int. Cl. G01S 17/50

(52) U.S. Cl. CPC G01S 17/50
USPC 356/5.01

(57) ABSTRACT

A time of flight (ToF) sensor comprises a light source configured to irradiate light on a subject, a sensing unit comprising a sensing pixel array configured to sense light reflected from the subject and to generate a distance data signal, and a control unit comprising a view angle control circuit. The view angle control circuit is configured to detect movement of the subject based on the distance data signal received from the sensing unit and to control a view angle of the sensing unit to increase a number of sensing pixels in the sensing pixel array that are used to sense a region in which the detected movement occurs.

### CROSS-REFERENCE TO RELATED APPLICATIONS

This application claims priority under 35 U.S.C. §119 to Korean Patent Application No. 10-2012-0023600 filed on Mar. 7, 2012, the subject matter of which is hereby incorporated by reference.

### BACKGROUND OF THE INVENTION

The inventive concept relates generally to time of flight (ToF) sensors. More particularly, certain embodiments of the inventive concept relate to a ToF sensor that can be adjusted in response to activity such as motion within its sensing field.

A ToF sensor is a device that determines the flight time of a signal of interest. For example, an optical ToF sensor may determine the time of flight of an optical signal (e.g., near infrared light at ˜850 nm) by detecting its time of emission from a light source (t_em), detecting its time of reception at a light sensor (t_re), and then subtracting the time of reception from the time of emission according to the following equation ToF=t_re−t_em, referred to as equation (1).

In some applications, a ToF sensor may be used to determine the location of nearby objects. For instance, an optical ToF sensor may determine an approximate distance “D” to an object by relating the time of flight as calculated in equation (1) to the speed of light “c”, as in the following equation D=(ToF*c)/2, referred to as equation (2). In equation (2), it is assumed that the distance D between the ToF sensor and the object is one half of the total distance traveled by the emitted optical signal.

In addition to determining the location of objects, a ToF sensor can also be used to detect motion. This can be accomplished, for instance, by detecting changes in the distance D over time. In particular, if the detected distance D changes for a particular sensing region of the ToF sensor, these changes can be interpreted to indicate relative motion between the ToF sensor and one or more objects.

Although many ToF sensors can obtain relatively accurate distance information, they are somewhat limited due to low resolution. For example, unlike digital cameras, ToF sensors are not generally designed with large arrays of pixel sensors. Consequently, it can be difficult for conventional ToF sensors to produce high resolution information regarding motion or other phenomena within its field of sensing.

### SUMMARY OF THE INVENTION

In one embodiment of the inventive concept, a ToF sensor comprises a light source configured to irradiate light on a subject, a sensing unit comprising a sensing pixel array configured to sense light reflected from the subject and to generate a distance data signal, and a control unit comprising a view angle control circuit. The view angle control circuit is configured to detect movement of the subject based on the distance data signal received from the sensing unit and to control a view angle of the sensing unit to increase a number of sensing pixels in the sensing pixel array that are used to sense a region in which the detected movement occurs.

In another embodiment of the inventive concept, a ToF camera comprises a light source configured to irradiate light on a subject, a sensing unit comprising a sensing pixel array configured to sense light reflected from the subject and to generate a distance data signal, a ToF sensor comprising a control unit comprising a view angle control circuit, and a two-dimensional (2D) image sensor configured to obtain 2D image information of the subject. The view angle control circuit is configured to detect movement of the subject based on the distance data signal received from the sensing unit and to control a view angle of the sensing unit to increase a number of sensing pixels in the sensing pixel array that are used to sense a region in which the detected movement occurs.

In another embodiment of the inventive concept, a method comprises irradiating light on a subject, sensing light reflected from the subject and generating a distance data signal based on the sensed light, detecting movement of the subject based on the distance data signal, and controlling a view angle of the sensing unit to increase a number of sensing pixels in the sensing pixel array that are used to sense a region in which the detected movement occurs.

These and other embodiments of the inventive concept can potentially improve the sensing performed by a ToF sensor or ToF camera by increasing the sensor's resolution according to observed motion.

### BRIEF DESCRIPTION OF THE DRAWINGS

The drawings illustrate selected embodiments of the inventive concept. In the drawings, like reference numbers indicate like features, and the relative sizes of various features may be exaggerated for clarity of illustration.

FIG. 1 is a block diagram of a ToF sensor according to an embodiment of the inventive concept.

FIGS. 2A through 3B are pixel array diagrams illustrating operations of the ToF sensor of FIG. 1 according to an embodiment of the inventive concept.

FIG. 4 is a more detailed block diagram of the ToF sensor of FIG. 1 according to an embodiment of the inventive concept.

FIG. 5 is a block diagram of a ToF sensor according to another embodiment of the inventive concept.

FIG. 6 is a block diagram of a ToF sensor according to another embodiment of the inventive concept.

FIGS. 7A through 7D are diagrams of segment shapes classified according to segment shape sample data stored in a segment shape sample buffer according to an embodiment of the inventive concept.

FIG. 8 is a block diagram of a ToF sensor according to another embodiment of the inventive concept.

FIGS. 9A through 9C are diagrams illustrating operations of an action calculation circuit according to an embodiment of the inventive concept.

FIG. 10 is a block diagram of a ToF sensor according to another embodiment of the inventive concept.

FIG. 11 is a block diagram of a system comprising the ToF sensor of FIG. 1, 5, 6, or 8 according to an embodiment of the inventive concept.

FIG. 12 is a block diagram of a computing system comprising the system of FIG. 11.

### DETAILED DESCRIPTION

Embodiments of the inventive concept are described below with reference to the accompanying drawings. These embodiments are presented as teaching examples and should not be construed to limit the scope of the inventive concept.

The terminology used herein is for the purpose of describing particular embodiments only and is not intended to be limiting of exemplary embodiments of the inventive concept. As used herein, the singular forms “a”, “an” and “the” are intended to include the plural forms as well, unless the context clearly indicates otherwise. The terms “comprises”, “comprising,”, “includes” and/or “including”, when used herein, indicate the presence of stated features, integers, steps, operations, elements, and/or components, but do not preclude the presence or addition of one or more other features, integers, steps, operations, elements, components, and/or groups thereof.

Although the terms first, second, third etc. may be used herein to describe various features, the described features should not be limited by these terms. Rather, these terms are used merely to distinguish between different features. Thus, a first feature could be termed a second feature and vice versa without materially changing the meaning of the relevant description.

Unless otherwise defined, all terms (including technical and scientific terms) used herein have the same meaning as commonly understood by one of ordinary skill in the art. Terms such as those defined in commonly used dictionaries should be interpreted as having a meaning that is consistent with their meaning in the context of the relevant art and will not be interpreted in an idealized or overly formal sense unless expressly so defined herein. Expressions such as “at least one of,” when preceding a list of elements, modify the entire list of elements and do not modify the individual elements of the list.

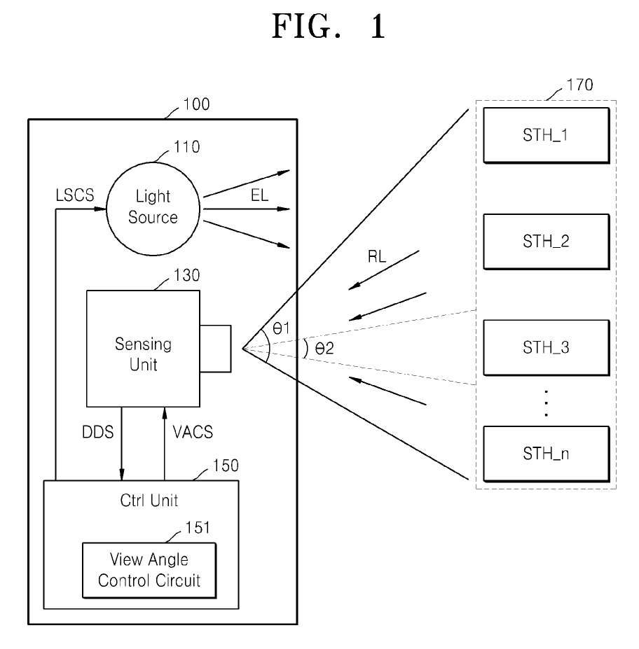

FIG. 1 is a block diagram illustrating a ToF sensor 100 according to an embodiment of the inventive concept.

Referring to FIG. 1, ToF sensor 100 comprises a light source 110, a sensing unit 130, and a control unit 150. Control unit 150 comprises a view angle control circuit 151.

Light source 110 emits light in response to a light source control signal LSCS. This light (“emitted light EL”) is irradiated onto subjects STH_1, SHT_2, STH_3, . . . , STH_n 170, which are defined as the contents of distinct regions of the sensing field of ToF sensor 100. Emitted light EL is reflected off of the subjects to produce reflected light RL, and reflected light RL is sensed by sensing unit 130.

Light source 110 typically comprises a device capable of high speed modulation such as a light-emitting diode (LED) or laser diode (LD). The light emitted by light source 110 may be light modulated into a waveform of a high frequency pulse P of about 200 MHz, for instance. The light may be continuously irradiated or it may be output in discrete pulses.

Sensing unit 130 senses light RL reflected from the subjects and generates a distance data signal DDS indicating respective distances between ToF sensor 100 and each of the subjects. Distance data signal DDS can be calculated based on equations (1) and (2) as described above.

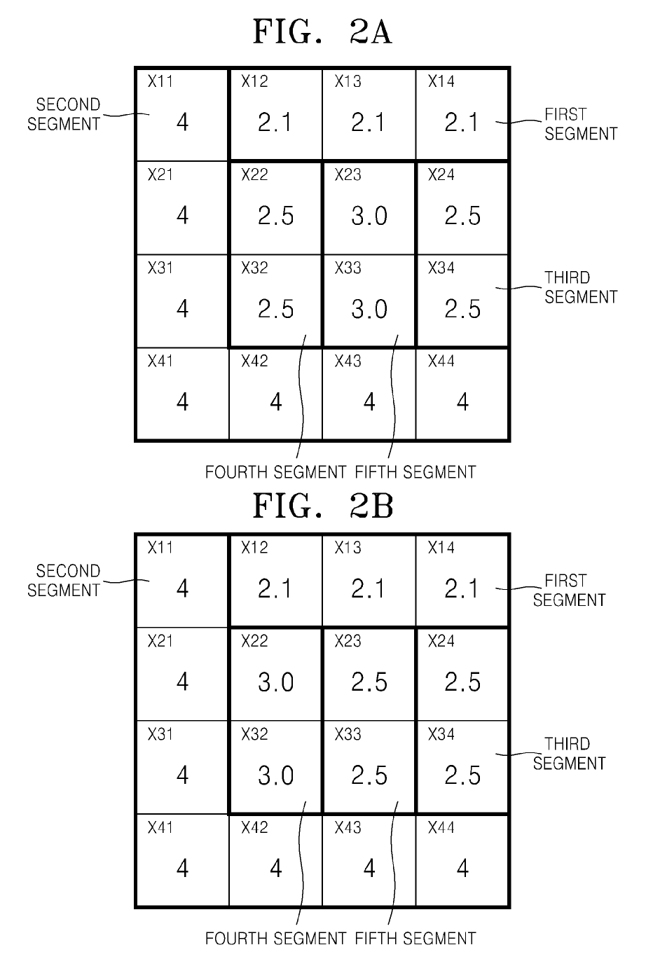

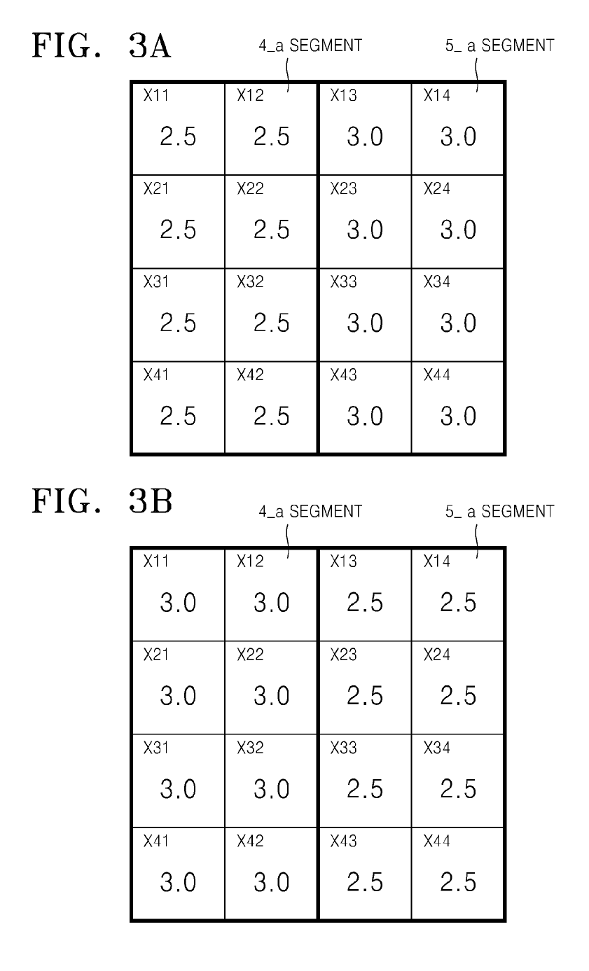

Sensing unit 130 comprises a sensing pixel array comprising a plurality of sensing pixels. Sensing unit 130 determines the respective distances between ToF sensor 100 and each of the subjects based on different signals sensed by each of the sensing pixels. For example, as illustrated in FIGS. 2 and 3, the sensing pixel array may comprise a 4×4 array of pixels to determine distances for sixteen different subjects within the sensing field.

Sensing unit 130 transfers distance data signal DDS to control unit 150 and receives a view angle control signal VACS. Sensing unit 130 the controls a view angle according to view angle control signal VACS. The view angle can be controlled, for instance, using a lens distance control method, a digital zooming method, or a super resolution method.

In certain embodiments, sensing unit 130 controls the view angle to include a region in which a certain pattern of motion is detected. For instance, it may adjust the view angle to focus on a region where the distance D exhibits a relatively large change over time. Such a region can be referred to as a dynamic region. The adjustment of the view angle can also be performed on the basis of segmented portions of the sensing pixel array. For instance, the view angle may be adjusted to focus on a segment comprising multiple pixels that change in a similar manner, indicating that they may be part of the same object.

Control unit 150 receives distance data signal DDS from sensing unit 130 to generate view angle control signal VACS. Control unit 150 comprises a view angle control circuit 151, which processes distance data signal DDS to generate view angle control signal VACS. A method of generating view angle control signal VACS is described below in further detail.

During typical operation of ToF sensor 100, light source 110 transmits emitted light EL to subjects STH_1, SHT_2, STH_3, . . . , STH_n 170. Sensing unit 130 senses light RL reflected from subjects STH_1, SHT_2, STH_3, . . . , STH_n 170, generates distance data signal DDS and transmits it to control unit 150. Control unit 150 may receive distance data signal DDS to generate view angle control signal VACS. The operation of receiving distance data signal DDS and generating view angle control signal VACS is typically performed by view angle control circuit 151.

Sensing unit 130 controls the view angle according to view angle control signal VACS. For example, if subject STH_3 exhibits a greatest amount of motion among subjects STH_1, SHT_2, STH_3, . . . , STH_n 170, the view angle may be contracted from θ1 to θ2 so that sensing unit 130 receives only light reflected from the subject STH_3 may be received. Where the view angle is contracted from θ1 to θ2, an area of a subject corresponding to a sensing pixel included in sensing unit 130 is reduced. Thus, the number of pixels corresponding to the subject STH_3 increases, and data regarding subject STH_3 may be collected with higher resolution. In other words, data regarding a more dynamic or active region may be collected with higher resolution.

FIGS. 2A through 3B are pixel array diagrams illustrating operations of ToF sensor 100 according to an embodiment of the inventive concept. In each of FIGS. 2A through 3B, a pixel array is illustrated as a 4×4 grid of sensing pixels. Each sensing pixel captures a portion of reflected light RL in order to generate a distance measurement for a corresponding subject within a sensing field defined by the viewing angle of sensing unit 130. These distance measurements are shown in each of the sensing pixels of FIGS. 2A through 3B. The distance measurements shown in FIGS. 2A and 2B were captured with a relatively wide viewing angle, and the distance measurements shown in FIGS. 3A and 3B were captured with narrower viewing angle.

Referring to FIG. 2A, at a time “t”, distance measurements were captured by the sensing pixels for each of 16 different regions. Based on these distance measurements, the sensing pixels were segmented based on the similarity of values. For instance, a first segment is formed by sensing pixels X12, X13, and X14 having the same value of distance measurements. A second segment is formed by sensing pixels X11, X21, and X31, X41, X42, X43, X44 having the same value of distance measurements. Similarly, third through fifth segments were formed in a similar manner.

Referring to FIG. 2B, at a time t+Δt, distance measurements were again captured by the sensing pixels for each of 16 different regions. Motion can then be detected based on differences between the distances measurements as shown in FIGS. 2A and 2B. In particular, differences between the distance measurements in the fourth and fifth segments indicates that motion has occurred in these segments. Accordingly, the viewing angle of sensing unit 130 can be adjusted to focus on the fourth and fifth segments.

Referring to FIG. 3A, at a time t+2Δt, the sensing pixels of sensing unit 130 are adjusted to capture higher resolution data of the fourth and fifth segments shown in FIGS. 2A and 2B. These higher resolution versions of the fourth and fifth segments are referred to as 4_{—}a segment and 5_{—}a segment, respectively.

Referring to FIG. 3B, at a time t+3Δt, the distance measurements of the sensing pixels again change, reflecting further motion in the fourth and fifth segments. However, due to the adjusted viewing angle, the further motion is reflected in higher resolution than in FIGS. 2A and 2B.

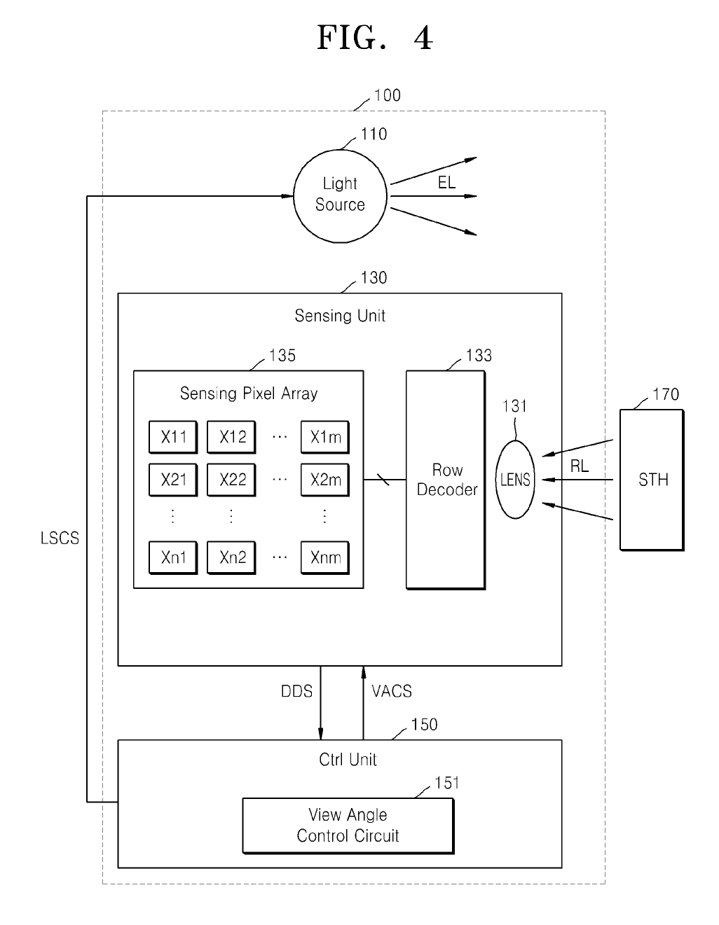

FIG. 4 is a more detailed block diagram of ToF sensor 100 of FIG. 1 according to an embodiment of the inventive concept.

Referring to FIG. 4, ToF 100 is formed with the features as in FIG. 1, but sensing unit 130 is shown with a lens 131, row decoder 133, and a sensing pixel array 135. Lens 131 has a substantially uniform time interval and receives reflected light RL reflected from subject 170. For example, where light source 110 continuously emits a pulse light, lens 131 may receive the reflected light RL reflected at the uniform time interval by opening and closing an aperture thereof. The reflected light RL is converted into an electrical signal in a sensing pixel.

Sensing pixel array 135 comprises a plurality of pixels Xij (iε1˜m, jε1˜n) in a 2D matrix of rows and columns and constitutes a rectangular imaging region. Pixels Xij can be identified by a combination of row and column addresses. Each of pixels Xij typically comprises at least one photoelectric conversion device implemented as a photo diode, a photo transistor, a photo gate, or a pinned photo diode.

Row decoder 133 generates driving signals and gate signals to drive each row of sensing pixel array 135. Row decoder 133 selects pixels Xij (where i=1˜m, j=1˜n) of sensing pixel array 135 in a row unit using the driving signals and gate signals. Sensing unit 130 generates the distance data signal from pixel signals output from pixels Xij.

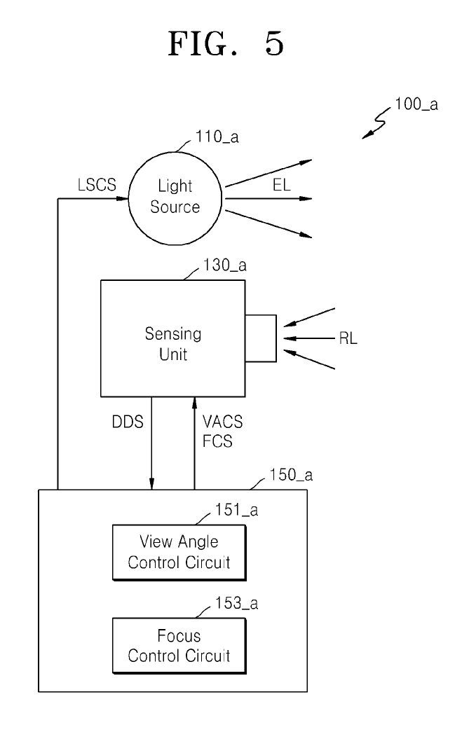

FIG. 5 is a block diagram of a ToF sensor 100_{—}a, according to another embodiment of the inventive concept.

Referring to FIG. 5, ToF sensor 100_{—}a comprises a light source 110_{—}a, a sensing unit 130_{—}a, and a control unit 150_{—}a. Control unit 150_{—}a comprises a view angle control circuit 151_{—}a and a focus control circuit 153_{—}a. Light source 110_{—}a and sensing unit 130_{—}a operate similar to light source 110 and sensing unit 130, respectively. Thus, redundant descriptions of these features will be omitted.

Sensing unit 130_{—}a transfers distance data signal DDS to control unit 150_{—}a and receives view angle control signal VACS and a focus control signal FCS. Sensing unit 130_{—}a controls a view angle according to view angle control signal VACS and a focus according to focus control signal FCS.

Control unit 150_{—}a receives distance data signal DDS from sensing unit 130_{—}a and generates view angle control signal VACS and focus control signal FCS. Control unit 150_{—}a comprises view angle control circuit 151_{—}a and focus control circuit 153_{—}a. View angle control circuit 151_{—}a processes distance data signal DDS to generate view angle control signal VACS. Focus control circuit 153_{—}a processes distance data signal DDS and view angle control signal VACS to generate focus control signal FCS.

During typical operation of ToF sensor 100_{—}a, sensing unit 130_{—}a senses light reflected from subjects and generates distance data signal DDS. Sensing unit 130_{—}a transfers distance data signal DDS to control unit 150_{—}a. Control unit 150_{—}a receives distance data signal DDS and generates view angle control signal VACS and focus control signal FCS. The operation of receiving distance data signal DDS and generating view angle control signal VACS may be performed by view angle control circuit 151_{—}a of control unit 150_{—}a. Sensing unit 130_{—}a controls the view angle and the focus according to view angle control signal VACS and focus control signal FCS. This may allow data to be collected with greater precision.

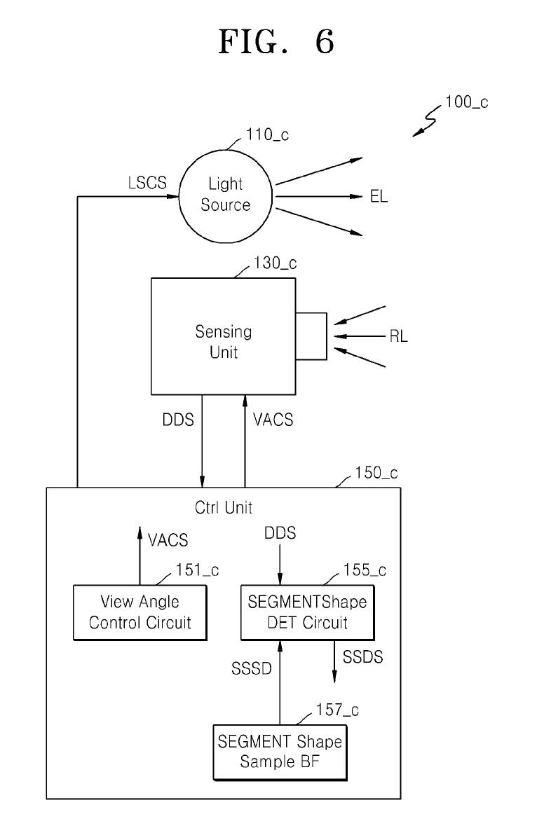

FIG. 6 is a block diagram of a ToF sensor 100_{—}c according to another embodiment of the inventive concept.

Referring to FIG. 6, ToF sensor 100_{—}c comprises a light source 110_{—}c, a sensing unit 130_{—}c, and a control unit 150_{—}c. Control unit 150_{—}c comprises a view angle control circuit 151_{—}c, a segment shape determination circuit 155_{—}c, and a segment shape sample buffer 157_{—}c. Light source 110_{—}c and sensing unit 130_{—}c of ToF sensor 100_{—}c operate similar to light source 110 and sensing unit 130, respectively, so a redundant description of these features will be omitted.

Control unit 150_{—}c receives distance data signal DDS from sensing unit 130_{—}c and transfers distance data signal DDS to segment shape determination circuit 155_{—}c. Segment shape determination circuit 155_{—}c processes distance data signal DDS and generates a segment shape data signal SSDS. Segment shape data signal SSDS is used to classify each part of a subject corresponding to a pixel array into one or more segments. More specifically, a segment shape may be determined by classifying pixels having the same distance data or within a previously determined range into the same segment. For example, referring to FIG. 2A, a distance from ToF sensor 100 to a subject is 2.1 meters, and corresponding pixels X12, X13, and X14 are designated as the first segment. Similarly, a distance from ToF sensor 100 to another subject is 4 meters, and the corresponding pixels X11, X21, X31, and X41 are designated as the second segment.

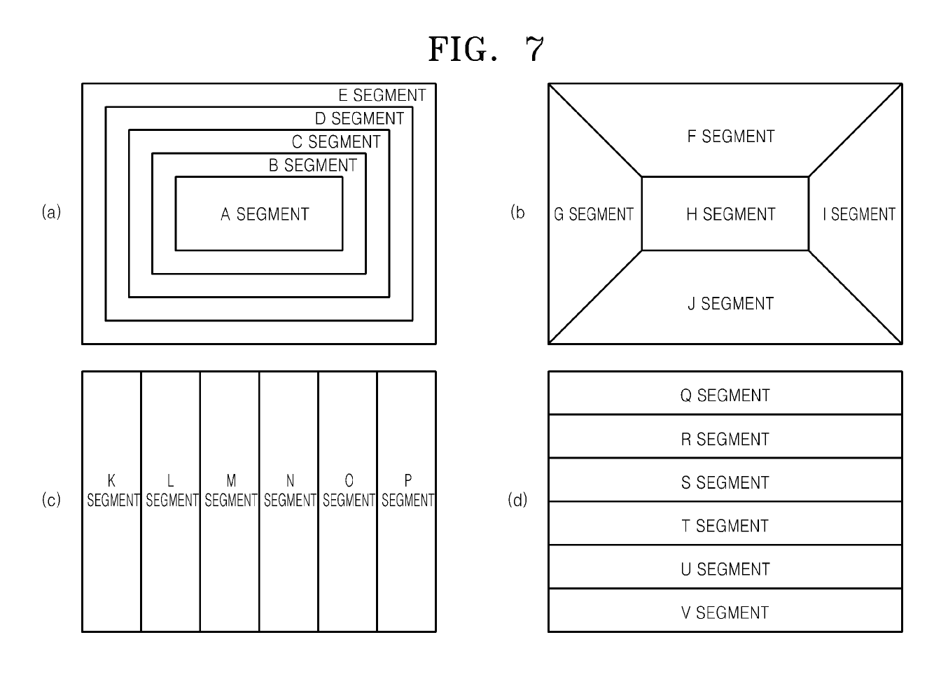

FIGS. 7A through 7D are diagrams of shapes of segments classified according to segment shape sample data DSSD stored in segment shape sample buffer 157_{—}c according to an embodiment of the inventive concept.

Referring to FIGS. 7A through 7D, segment shape determination circuit 155_{—}c generates segment shape data signal SSDS based on segment shape sample data SSSD stored in segment shape sample buffer 157_{—}c. Segment shape determination circuit 155_{—}c generates segment shape data signal SSDS according to properties of a subject. For example, where the subject has a uniform pattern, segment shape data signal SSDS may be generated by using database regarding a previously stored outline shape of a human face. Thus, a variety of segments may be determined more efficiently according to an outline shape of the subject.

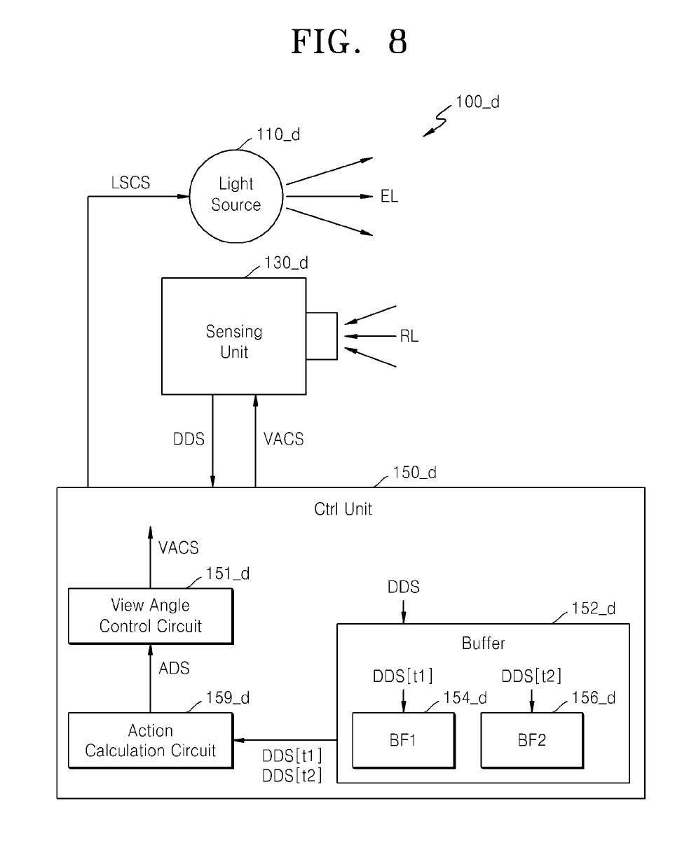

FIG. 8 is a block diagram of a ToF sensor 100_{—}d according to another embodiment of the inventive concept.

Referring to FIG. 8, ToF sensor 100_{—}d comprises a light source 110_{—}d, a sensing unit 130_{—}d, and a control unit 150_{—}d. Control unit 150_{—}d comprises a view angle control circuit 151_{—}d, an action calculation circuit 159_{—}d, and a sensing data buffer 152_{—}d. Light source 110_{—}d and sensing unit 130_{—}d of ToF sensor 100_{—}d operate similar to light source 110 and sensing unit 130 of ToF sensor 100, so a redundant description of these features will be omitted.

Control unit 150_{—}d receives distance data signal DDS from sensing unit 130_{—}dc and generates view angle control signal VACS. Sensing data buffer 152_{—}d receives distance data signal DDS, which is a signal generated by receiving light in a lens in sensing unit 130_{—}d at a substantially uniform time interval. For example, a distance data signal DDS[t1] generated at a time t1 may correspond to each subject as shown in FIG. 2A. Further, a distance data signal DDS[t2] generated at a time t2 may correspond to each subject as shown in FIG. 2B. In this case, distance data signal DDS[t1] may be stored in a first buffer BF1 154_{—}d, and distance data signal DDS[t2] may be stored in a second buffer BF2 156_{—}d. Sensing data buffer 152_{—}d may continuously receive distance data signal DDS and alternately store distance data signal DDS in the first buffer BF1 154_{—}d and the second buffer BF2 156_{—}d.

Action calculation circuit 159_{—}d processes distance data signal DDS and generates an action determination signal ADS. Action calculation circuit 159_{—}d receives distance data stored in first buffer BF1 154_{—}d and second buffer BF2 156_{—}d and calculates a difference between the distance data corresponding to each cell. The difference between the distance data corresponding to each cell may be defined as an action value indicating an action of a par corresponding to each cell. Action calculation circuit 159_{—}d classifies a segment into a region in which an action of a subject takes place and a background region according to whether the action value is greater than a threshold. Action determination signal ADS may include information regarding the action value. Action calculation circuit 159_{—}d calculates the action value according to a variation in a distance from the subject to a reflected subject.

Control unit 150_{—}d classifies the segment as a dynamic region in which a relatively high amount of motion or action occurs or a background region in which a relatively low amount of motion or action occurs. The distinctions between high and low amounts of action can be determined, for instance, by assigning an action value to a segment and comparing the action values to a threshold. Where the action value is greater than the threshold, control unit 150_{—}d may classify the segment as a dynamic region. Otherwise, it may classify the segment as a background region.

Control unit 150_{—}d may controls the view angle of sensing unit 130_{—}d to exclude the background region. Control unit 150_{—}d may update the action values of different segments, and reclassify segments as dynamic regions of background regions. Where a segment includes two or more regions where action takes place, control unit 150_{—}d may select a region in which the action occurs more frequently to control the view angle. The region in which the action of the subject occurs more frequently may be a region having the highest action value among the plurality of segments shown in FIGS. 7A through 7D. View angle control circuit 151_{—}c receives action determination signal ADS and generates view angle control signal VACS.

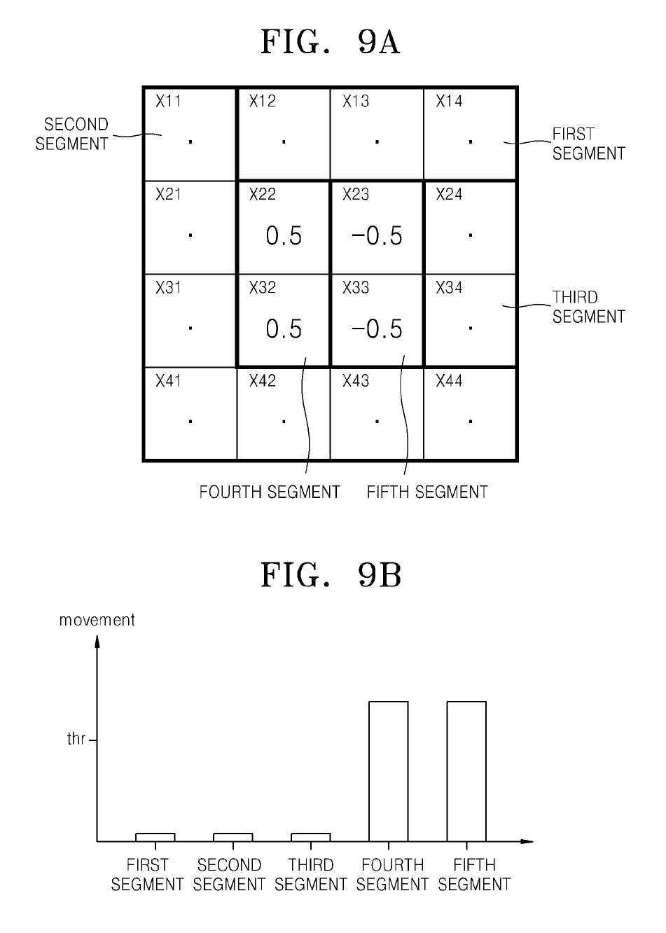

FIGS. 9A through 9C are diagrams illustrating operations of action calculation circuit 159_{—}d according to an embodiment of the inventive concept.

FIG. 9A is a diagram of action values calculated through continuous sensing with respect to the segments of FIGS. 2A and 2B. Referring to FIG. 9A, action calculation circuit 159_{—}d measures each action of a subject with respect to the segments of FIGS. 2A and 2B. A difference in distance data corresponding to each cell, i.e. an action value, may be calculated as shown in FIG. 9A. Where the action value exceeds a threshold thr, action of the subject may be determined to take place.

FIG. 9B is a graph illustrating whether action values of the classified segments of FIGS. 2A and 2B exceed threshold thr. Referring to FIG. 9B, the action of the subject may be determined to take place with respect to the fourth and fifth segments having action values that exceed threshold thr. Control unit 150_{—}d generates view angle control signal VACS in such a way that sensing unit 130_{—}d controls a view angle in accordance with the fourth and fifth segments.

FIG. 9C is a graph illustrating whether action values of the classified segments of FIGS. 2A and 2B exceed threshold thr with respect to distances. Referring to FIG. 9C, control unit 150_{—}d focuses a distance to a segment including an action determined by action calculation circuit 159_{—}d. For example, where the fourth and fifth segments have high action values as shown in FIG. 9B, control unit 150_{—}d focuses an average distance of the fourth and fifth segments.

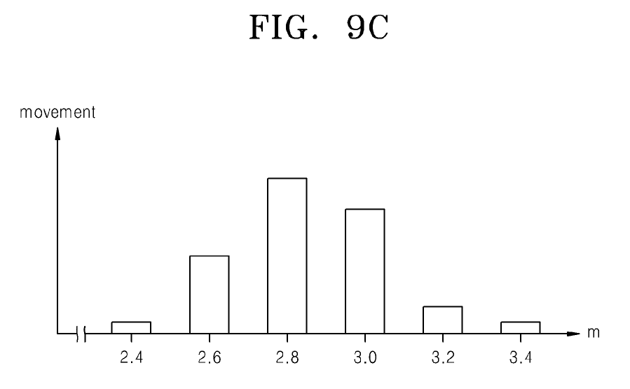

FIG. 10 is a block diagram of a ToF sensor 100_{—}e according to another embodiment of the inventive concept.

Referring to FIG. 10, ToF sensor 100_{—}e comprises a light source 100_{—}e, a sensing unit 130_{—}e, a view angle control unit 151_{—}e, a focus control unit 153_{—}e, a segment shape determination unit 155_{—}e, a segment shape sample buffer 157_{—}e, a sensing data buffer 152_{—}e, a comparison unit 158_{—}e, and an action determination unit 159_{—}e.

During typical operation of ToF sensor 100_{—}e, light source 110_{—}e irradiates the light EL to a subject. A lens 131_{—}e of sensing unit 130_{—}e receives light EL reflected from the subject at a uniform time interval. For example, where light source 110_{—}e continuously emits pulse light, lens 131_{—}e may receive emitted light EL reflected at the uniform time interval by opening and closing an aperture thereof. Row decoder 133_{—}e selects pixels Xij of sensing pixel array 135_{—}e in a unit of row in response to driving signals and gate signals. Sensing unit 130_{—}e generates distance data signal DDS from pixel signals output from pixels Xij.

Sensing data buffer 152_{—}e receives distance data signal DDS. Distance data signal DDS[t1] generated at time t1 is stored in first buffer BF1 154_{—}e, and distance data signal DDS[t2] is stored in second buffer BF2 156_{—}e. Sensing data buffer 152_{—}e continuously receives distance data signal DDS and alternately stores distance data signal DDS in first buffer BF1 154_{—}e and second buffer BF2 156_{—}e. Distance data signal DDS[t1] stored in first buffer BF1 154_{—}e is transferred to segment shape determination unit 155_{—}e. Segment shape determination unit 155_{—}e generates segment shape data signal SSDS based on segment shape sample data SSSD.

Distance data signal DDS[t1] and distance data signal DDS[t2] is transferred to comparison unit 158_{—}e to compare distance information corresponding to each pixel. Comparison unit 158_{—}e calculates a difference in the distance information corresponding to each pixel to generate a comparison signal CS. Comparison unit 158_{—}e transfers comparison signal CS to action determination unit 159_{—}e. Action determination unit 159_{—}e determines whether the difference in the distance information corresponding to each pixel exceeds a threshold to generate action determination signal ADS. Action determination signal ADS may include information regarding whether there is an action in each corresponding cell. Action determination signal ADS comprises information used to classify a cell including the action and a cell including no action.

Action determination signal ADS is transferred to view angle control unit 151_{—}e and focus control unit 153_{—}e. View angle control unit 151_{—}e generates view angle control signal VACS using action determination signal ADS in such a way that sensing unit 130_{—}e may control a view angle in accordance with a size and location of a part including the action. Focus control unit 153_{—}e generates focus control signal FCS in such a way that sensing unit 130_{—}e controls a focus in accordance with a distance of the part including the action. Thus, data regarding a part including many actions may be more concretely collected.

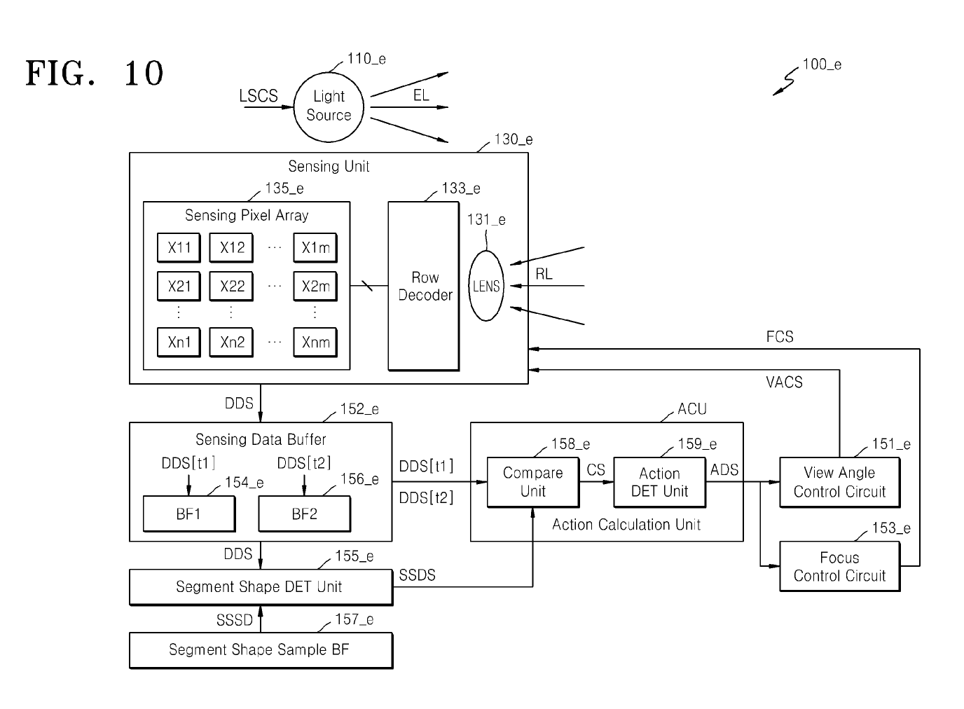

FIG. 11 is a block diagram of a ToF sensor system 160 using ToF sensor 100, 100_{—}a, 100_{—}c, or 100_{—}d of FIG. 1, 5, 6, or 8, according to an embodiment of the inventive concept. ToF sensor system 160 may be, for instance, a ToF camera.

Referring to FIG. 11, ToF sensor system 160 comprises a processor 161 coupled to the ToF sensors 100, 100_{—}a, 100_{—}c, and 100_{—}d. ToF sensor system 160 may include an individual integrated circuit or, processor 161 and ToF sensor 100, 100_{—}a, 100_{—}c, or 100_{—}d may be disposed on the same integrated circuit. Processor 161 may be a microprocessor, an image processor, or any of other types of control circuits such as an application-specific integrated circuit (ASIC). Processor 161 comprises an image sensor control unit 162, an image signal processing unit 163, and an interface unit 164. Image sensor control unit 162 outputs a control signal to ToF sensor 100, 100_{—}a, 100_{—}c, or 100_{—}d. Image signal processing unit 163 receives image data including distance information output from ToF sensor 100, 100_{—}a, 100_{—}c, or 100_{—}d and performs signal processing on the image data. Interface unit 164 transfers the image data on which signal processing is performed to a display 165 to reproduce the image data.

ToF sensor 100, 100_{—}a, 100_{—}c, or 100_{—}d comprises a plurality of pixels, and it obtains the distance information from at least one of the pixels. ToF sensor 100, 100_{—}a, 100_{—}c, or 100_{—}d removes a pixel signal obtained from background light from the pixel signal obtained from modulation light and the background light. ToF sensor 100, 100_{—}a, 100_{—}c, or 100_{—}d generates a distance image by calculating the distance information of a corresponding pixel based on the pixel signal from which the pixel signal obtained from the background light is removed. ToF sensor 100, 100_{—}a, 100_{—}c, or 100_{—}d may generate a distance image of a target by combining the distance information of the pixels.

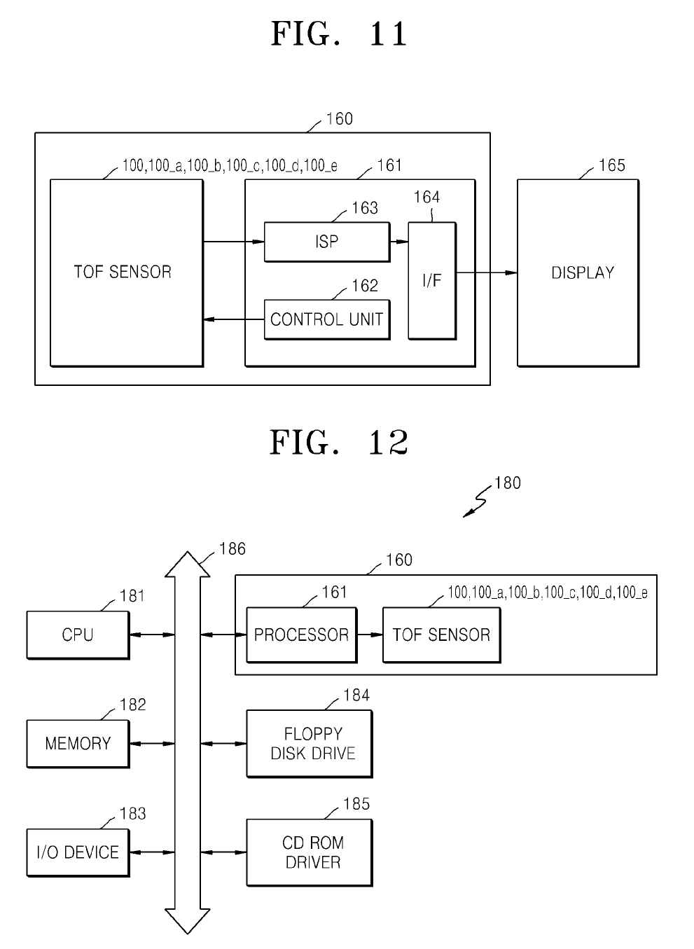

FIG. 12 is a block diagram of a computing system 180 comprising ToF sensor system 160 of FIG. 11.

Referring to FIG. 12, computing system 180 comprises ToF sensor system 160, a central processing unit 181, a memory 182, and an I/O device 183. Computing system 180 further comprises a floppy disk drive 184 and a CD ROM drive 185. Computing system 180 is connected to central processing unit 181, memory 182, I/O device 183, floppy disk drive 184, CD ROM drive 185, and ToF sensor system 160 via a system bus 186. Data provided through I/O device 183 or ToF sensor system 160 or processed by central processing unit 181 is stored in memory 182. Memory 182 may be configured as a RAM. Memory 182 may be configured as a memory card including a non-volatile memory device like a NAND flash memory.

ToF sensor system 160 includes ToF sensor 100, 100_{—}a, 100_{—}c, or 100_{—}d and processor 161 for controlling ToF sensor 100, 100_{—}a, 100_{—}c, or 100_{—}d. ToF sensor 100, 100_{—}a, 100_{—}c, or 100_{—}d includes a plurality of pixels, and may obtain the distance information from at least one of the pixels. ToF sensor 100, 100_{—}a, 100_{—}c, or 100_{—}d removes a pixel signal obtained from background light from the pixel signal obtained from modulation light and the background light. ToF sensor 100, 100_{—}a, 100_{—}c, or 100_{—}d generates a distance image by calculating the distance information of a corresponding pixel based on the pixel signal from which the pixel signal obtained from the background light is removed. ToF sensor 100, 100_{—}a, 100_{—}c, or 100_{—}d generates a distance image of a target by combining the distance information of the pixels.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims.

What is claimed is:

1. A time of flight (ToF) sensor, comprising:
a light source configured to irradiate light on a subject;
a sensing unit comprising a sensing pixel array configured to sense light reflected from the subject and to generate a distance data signal; and
a control unit comprising a view angle control circuit,
wherein the view angle control circuit is configured to detect movement of the subject based on the distance data signal received from the sensing unit and to control a view angle of the sensing unit to increase a number of sensing pixels in the sensing pixel array that are used to sense a region in which the detected movement occurs.

2. The ToF sensor of claim 1, wherein the control unit further comprises a focus control circuit, wherein, after the view angle control circuit controls the view angle, the focus control circuit generates a focus control signal and transfers the focus control signal to the sensing unit to adjust a focus of the sensing unit according to the region in which the detected movement occurs.

3. The ToF sensor of claim 1, wherein the control unit further comprises a segment shape determination circuit configured to generate a segment shape determination signal used to classify each part of the subject corresponding to each pixel of the sensing pixel array into at least one segment according to the distance data signal, and wherein the sensing unit receives the segment shape determination signal and classifies each part of the subject into the at least one segment.

4. The ToF sensor of claim 3, wherein the control unit further comprises a segment shape sample buffer for storing segment shape sample data, wherein the segment shape determination circuit generates the segment shape determination signal based on the segment shape sample data stored in the segment shape sample buffer.

5. The ToF sensor of claim 3, wherein the segment shape determination circuit generates the segment shape determination signal according to properties of the subject.

6. The ToF sensor of claim 1, wherein the control unit further comprises an action calculation circuit configured to calculate an action value indicating a magnitude of the movement, wherein the action calculation circuit classifies a segment as a dynamic region or a background region according to whether the action value is greater than a threshold.

7. The ToF sensor of claim 6, wherein the control unit controls the view angle to exclude the background region.

8. The ToF sensor of claim 7, wherein the control unit controls the view angle by updating the action value reclassifying the segment as the dynamic region or the background region, and excluding the background region.

9. The ToF sensor of claim 7, wherein, if the segment includes two or more regions in which the movement of the subject takes, the control unit controls the view angle by selecting the region in which the movement of the subject occurs with greater frequency.

10. The ToF sensor of claim 6, wherein the action calculation circuit calculates the action value according to a variation in a frequency of the light reflected from the subject, a variation in intensity of the light, or a variation in the distance to the subject.

11. A ToF camera, comprising:
a light source configured to irradiate light on a subject;
a sensing unit comprising a sensing pixel array configured to sense light reflected from the subject and to generate a distance data signal;
a ToF sensor comprising a control unit comprising a view angle control circuit; and
a two-dimensional (2D) image sensor configured to obtain 2D image information of the subject,
wherein the view angle control circuit is configured to detect movement of the subject based on the distance data signal received from the sensing unit and to control a view angle of the sensing unit to increase a number of sensing pixels in the sensing pixel array that are used to sense a region in which the detected movement occurs.

12. The ToF camera of claim 11, wherein the 2D image processor controls the view angle to control the view angle of the ToF sensor, and further controls a focus control circuit to control focus on the region in which the detected movement occurs.

13. The ToF camera of claim 11, wherein the 2D image processor tilts a main body of the ToF camera to the region in which the detected movement occurs.

14. The ToF camera of claim 11, wherein the 2D image processor further comprises a segment shape determination circuit that generates a segment shape determination signal to classify segments of the sensing pixel array as dynamic regions or background regions.

15. The ToF camera of claim 11, wherein the 2D image processor controls the view angle to exclude background regions.

16. A method, comprising:
irradiating light on a subject;
sensing light reflected from the subject and generating a distance data signal based on the sensed light;
detecting movement of the subject based on the distance data signal; and
controlling a view angle of the sensing unit to increase a number of sensing pixels in the sensing pixel array that are used to sense a region in which the detected movement occurs.

17. The method of claim 16, wherein the irradiated light comprises near-infrared light.

18. The method of claim 16, wherein controlling the view angle comprises contracting the view angle.

19. The method of claim 16, wherein sensing the light comprises operating a sensing pixel array to sense reflected light from different regions of a sensing field.

20. The method of claim 19, wherein detecting the movement comprises comparing successive frames of the sensing pixel array and identifying movement based on changes in sensing pixels between the successive frames.
